(19) United States
(12) Patent Application Publication
(10) Pub. No.: US 2013/0049553 A1
(43) Pub. Date: Feb. 28, 2013

(54) SPINDLE MOTOR

(71) Applicants: Jin Sun MIN, Suwon (KR); Ho Jun YOO, Suwon (KR)

(72) Inventors: Jin Sun MIN, Suwon (KR); Ho Jun YOO, Suwon (KR)

(73) Assignee: SAMSUNG ELECTRO-MECHANICS CO., LTD., Suwon (KR)

(21) Appl. No.: 13/489,330

(22) Filed: Jun. 5, 2012

(30) Foreign Application Priority Data
Aug. 22, 2011 (KR) 10-2011-0083591

(51) Int. Cl. H02K 1/14; H02K 11/00

(52) U.S. Cl. 310/68 D; 310/216.018

(57) ABSTRACT

Disclosed herein is a spindle motor including: a rotor part including a shaft and a rotor case coupled to the shaft to rotate integrally with the shaft, having a rotor magnet coupled to an inner side thereof, and having a disk mounted on one surface thereof; and a stator part including a base plate having the rotor part coupled thereto, a bearing part rotatably supporting the shaft, and an armature having a stator core part coupled to an outer peripheral surface of the bearing part so as to face the rotor magnet and a coil wound several times around the stator core part, wherein the stator core part is formed by stacking a plurality of stator cores having different thickness ratios.

### CROSS REFERENCE TO RELATED APPLICATION

This application claims the benefit of Korean Patent Application No. 10-2011-0083591, filed on Aug. 22, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, a spindle motor is a device mounted in a hard disk drive, an optical disk drive, and other recording media requiring high-speed rotation to drive a turntable, thereby rotating a disk mounted in the turntable.

A spindle motor according to the prior art is configured to include a shaft 10, a rotor case 13, a bearing holder 21 rotatably supporting the shaft 10, an armature 24 including a core assembly 22 formed by stacking a plurality of core layers and a coil 23 wound several times around the core assembly 22, a base plate 20 having a printed circuit board 25 coupled to an upper portion thereof, and a chucking assembly 27 including a turntable on which a disk is mounted, as shown in FIG. 1.

More specifically, the rotor case 13 includes a magnet 12 provided at an inner side thereof, wherein the magnet 12 generates electromagnetic force by electromagnetic interaction with the armature 24 to rotate the rotor case 13.

However, in order to be in accordance with design specifications of products in which the spindle motor is mounted, an internal space H of the rotor case 13 is variously changed in a design. Therefore, there is a limitation in a height of the core assembly 22.

As shown in FIG. 1, the core assembly 22 is formed by stacking a plurality of cores having the same thickness.

In addition, since the plurality of cores should be stacked so that a height h of the core assembly 22 is in accordance with the internal space H of the rotor case 13, more specifically, a height from an upper surface of the printed circuit board 25 covered by the rotor case 13 to an upper surface of an inner side of the rotor case 13, the number of stacked cores is increased or decreased.

Therefore, in the case in which the core assembly 22 is formed by stacking a plurality of cores having a specific single thickness, an optimized core assembly may not be positioned in the internal space H of the rotor case 13.

In addition, since the optimized core assembly may not be coupled to the spindle motor, electromagnetic interaction between the core assembly 22 and the magnet 12 is decreased.

Therefore, since driving force for driving the spindle motor may not be smoothly provided, the spindle motor may not arrive at a rotational speed section desired by a user.

### SUMMARY OF THE INVENTION

The present invention has been made in an effort to provide a spindle motor including a stator core part formed by stacking a plurality of stator cores having different thickness ratios.

According to a preferred embodiment of the present invention, there is provided a spindle motor including: a rotor part including a shaft and a rotor case coupled to the shaft to rotate integrally with the shaft, having a rotor magnet coupled to an inner side thereof, and having a disk mounted on one surface thereof; and a stator part including a base plate having the rotor part coupled thereto, a bearing part rotatably supporting the shaft, and an armature having a stator core part coupled to an outer peripheral surface of the bearing part so as to face the rotor magnet and a coil wound several times around the stator core part, wherein the stator core part is formed by stacking a plurality of stator cores having different thickness ratios.

The stator core part may be formed by stacking the plurality of stator cores in a bonding adhesion scheme of applying an adhesive between the stator cores having different thicknesses.

The rotor case may include: a disk part fixedly installed to the shaft at the center thereof and extended to one side; and an annular edge part vertically extended downwardly from a distal end of the disk part, wherein the annular edge part may have the rotor magnet to attached to an inner side thereof.

The stator part may further include a printed circuit board coupled to an upper portion of the base plate and applying power to the armature.

The bearing part may include: a bearing rotatably supporting the shaft; and a bearing holder coupled to an outer peripheral surface of the bearing to support the bearing and fixedly coupled to an upper portion of the base plate.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a spindle motor according to the prior art;

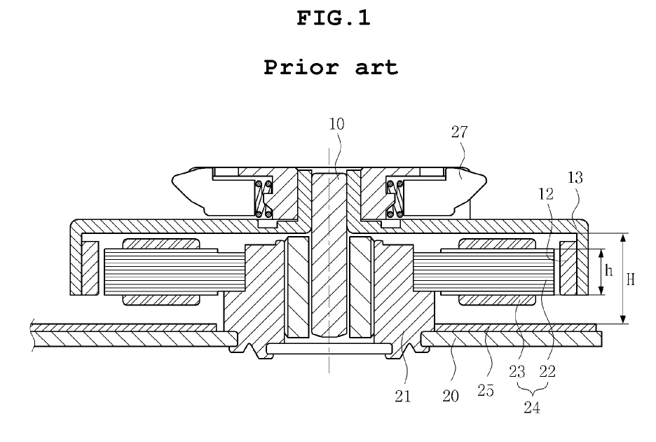

FIG. 2 is an enlarged view enlarging a stator area according to a preferred embodiment of the present invention; and

FIG. 3 is an analysis graph comparing the spindle motor according to the preferred embodiment of the present invention and the spindle motor according to the prior art.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

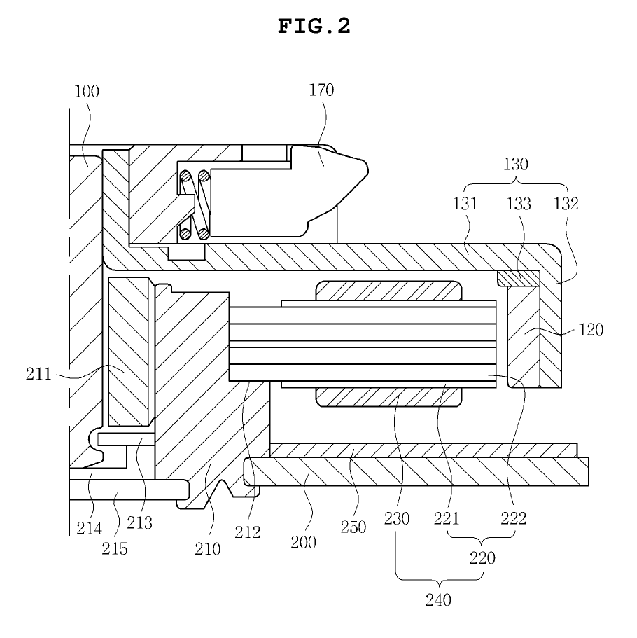

FIG. 2 is an enlarged view enlarging a stator area according to a preferred embodiment of the present invention. As shown in FIG. 2, a spindle motor according to the preferred embodiment of the present invention is configured to include a shaft 100, a rotor part including a rotor case 130 having a rotor magnet 120 coupled to an inner side thereof, a base plate 200, a bearing part, an armature 240, and a stator part including a printed circuit board 250.

More specifically, the shaft 100 is rotatably coupled to an upper portion of the base plate 200.

In addition, the shaft 100, which is a component rotating based on a central axis, is rotatably supported by the bearing part in a radial direction and includes a step part (not shown) stepped inwardly at a lower portion thereof, such that a lower end portion of the shaft has a convex curved surface.

Further, the shaft 100 has a stopper 213 interposed in the step part thereof, wherein the stopper 213 serves to prevent separation of the shaft 100.

In addition, the shaft 100 is rotatably supported by a thrust washer 214 and a support 215 in an axial direction.

Further, the rotor case 130 includes a disk part 131 and an annular edge part 132.

More specifically, the disk part 131 is extended in a direction perpendicular to the shaft 110 in a state in which a central portion thereof is press-fitted and coupled to the shaft 100.

In addition, the annular edge part 132 is vertically bent downwardly from a distal end of the disk part 131 to form an internal space between the annular edge part 132 and the shaft 100.

Here, a central portion of an upper surface of the disk part 131 is provided with a disk chucking device 170 for chucking a disk.

In addition, the rotor magnet 120 facing the armature 230 coupled to the internal space is coupled to an inner peripheral surface of the annular edge part 132, such that the rotor magnet 120 interacts with the armature 240 to generate electromagnetic force.

The disk chucking device 170, which is to chuck the disk, is extended in the direction perpendicular to the shaft 100 in which a central portion thereof is assembled to the shaft 100. In addition, the disk chucking device 170 may also be formed integrally with the rotor case 130.

As shown, the shaft 100 is rotatably coupled to the upper portion of the base plate 200 configuring the stator part according to the preferred embodiment of the present invention.

More specifically, the base plate 200, which is made of a metal material and is to entirely support components configuring the spindle motor, is coupled to a disk driving device in which the spindle motor is mounted.

In addition, an upper surface of the base plate 200 is formed with a circuit pattern supplying power to the armature 220.

More specifically, an upper portion of the printed circuit board 250 is mounted with a plurality of electronic elements such as an encoder, a connector, and a passive element.

Further, the printed circuit board 250 on which the plurality of electronic elements (not shown) are mounted is fixedly coupled to the upper portion of the base plate 200.

In addition, the printed circuit board 250 may be attached to the base plate 200 by a method such as a double-sided tape, a screwing method, a rivet, a caulking method, or the like.

As shown, the bearing part includes a bearing 211 and a bearing holder 210.

The bearing 211 rotatably supports the shaft 100 and has an outer peripheral surface supported by the bearing holder 210 having a cylindrical hollow part.

More specifically, the bearing holder 210, which is to support the bearing 211, has the hollow part (not shown) formed therein so that the bearing 211 is inserted thereinto, such that an inner peripheral surface thereof supports the bearing 211.

In addition, an outer peripheral surface of the bearing holder 210 is stepped so that a seat surface 212 on which the armature 240 is seated is provided.

Further, a lower end portion of the bearing holder 210 is coupled to the base plate 200 in a caulking or spinning scheme.

The armature 240 includes a stator core part 220 and a coil 230 wound several times around the stator core part 220.

More specifically, the stator core part 220 is coupled to the outer peripheral surface of the bearing holder 210 so as to face the rotor magnet 120.

Further, the stator core part 220 may be formed by stacking a plurality of stator cores having at least one different thickness ratio. However, as shown, the stator core part 220 according to the preferred embodiment of the present invention is formed by stacking two kinds of stator cores 221 and 222 having different thickness.

Further, in configuring the stator core part 220, the stator core part 220 is stacked in a bonding adhesion scheme of applying an adhesive between the stator core 221 and the stator core 222.

Therefore, in the case in which stack defect that another stator core 222 is skewed and stacked on the stator core 221 is generated at the time of manufacturing the stator core part 220, the skewed stator core 222 may be separated and reassembled.

In addition, a stack sequence of the stator cores having different thicknesses according to the exemplary embodiment of the present invention may be sequential according to a difference between the thicknesses or be changed.

Therefore, the stator core part formed by stacking the plurality of stator cores having different thickness ratios is provided, thereby making it possible to optimally adjust a height of the stator core part so as to be in accordance with an internal space of the rotor case.

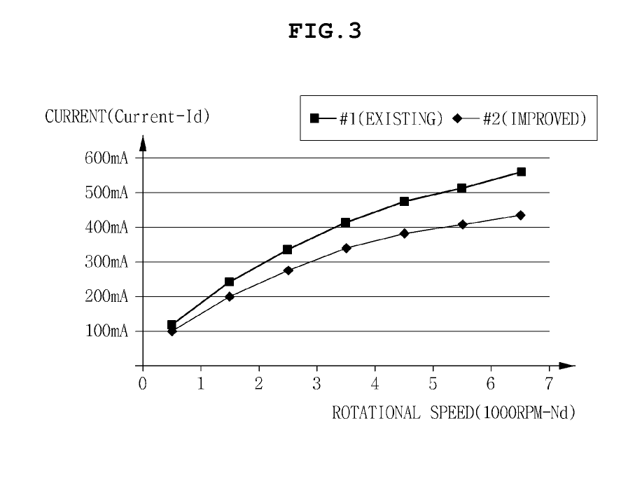

FIG. 3 is an analysis graph comparing the spindle motor according to the preferred embodiment of the present invention and the spindle motor according to the prior art. As shown in FIG. 3, a curve #1 in which rectangular points are shown indicates the spindle motor according to the prior (existing) art, and a curve #2 in which diamond points are shown indicates the spindle motor according to the exemplary embodiment of the present invention.

As shown in FIG. 3, as a result of configuring the stator core part 220 by stacking the plurality of stator cores 221 and 222 having different thickness ratios, a smaller amount of current was consumed at the same rotational speed as compared to the spindle motor according to the prior art.

More specifically, in a section of 1000 rpm to 2000 rpm, in order to rotate the spindle motor at approximately 1500 rpm, current of approximate 200 mA is consumed in the case of the spindle motor including the stator core part 220 in which the plurality of stator cores 221 and 222 are stacked; however, current of approximate 250 mA is consumed in the case of the spindle motor in which the plurality of stator cores having the same thickness are stacked.

That is, the number or the thickness ratio of stacked stator cores 221 and 222 having different thickness ratios is adjusted, thereby making it possible to provide the optimized stator core part 220 so as to be in accordance with the changed internal space of the rotor case 130.

Therefore, even though a small amount of current is applied to the coil 230, a rotational speed of the spindle motor desired by the user may be provided.

As set forth above, according to the preferred embodiment of the present invention, the stator core part formed by stacking the plurality of stator cores having different thickness ratios is provided, thereby making it possible to optimally adjust a height of the stator core part so as to be in accordance with an internal space of the rotor case variously changed according to specifications of products in which the spindle motor is mounted.

Therefore, the spindle motor having optimal specifications may be provided.

In addition, the plurality of stator cores having the different thickness ratios are provided, such that a height of the stator core part is variously adjusted, thereby making it possible to reduce a manufacturing cost.

Further, since the stator core part according to the preferred embodiment of the present invention is manufactured in the bonding adhesion scheme of applying an adhesive between the stator cores having the different thickness ratios, in the case in which the stack defect is generated at the time of manufacturing the stator core part, the stator core layer in which the stack defect is generated is separated and reassembled, thereby making it possible to improve a yield of the product and reduce a manufacturing cost thereof.

Furthermore, even though the internal space of the rotor case is changed, since the stator core part optimized for the changed specifications may be provided, even though a small amount of current is applied to the coil, a rotational speed of the spindle motor desired by the user may be provided.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a rotor part including a shaft and a rotor case coupled to the shaft to rotate integrally with the shaft, having a rotor magnet coupled to an inner side thereof, and having a disk mounted on one surface thereof; and
a stator part including a base plate having the rotor part coupled thereto, a bearing part rotatably supporting the shaft, and an armature having a stator core part coupled to an outer peripheral surface of the bearing part so as to face the rotor magnet and a coil wound several times around the stator core part,
wherein the stator core part is formed by stacking a plurality of stator cores having different thickness ratios.

2. The spindle motor as set forth in claim 1, wherein the stator core part is formed by stacking the plurality of stator cores in a bonding adhesion scheme of applying an adhesive between the stator cores having different thicknesses.

3. The spindle motor as set forth in claim 1, wherein the rotor case includes:
a disk part fixedly installed to the shaft at the center thereof and extended to one side; and
an annular edge part vertically extended downwardly from a distal end of the disk part,
the annular edge part having the rotor magnet attached to an inner side thereof.

4. The spindle motor as set forth in claim 1, wherein the stator part further includes a printed circuit board coupled to an upper portion of the base plate and applying power to the armature.

5. The spindle motor as set forth in claim 1, wherein the bearing part includes:
a bearing rotatably supporting the shaft; and
a bearing holder coupled to an outer peripheral surface of the bearing to support the bearing and fixedly coupled to an upper portion of the base plate.
